(19) United States
(12) Patent Application Publication
(10) Pub. No.: US 2016/0079841 A1
(43) Pub. Date: Mar. 17, 2016

(54) MOTOR-DRIVEN ELECTRIC GENERATOR

(71) Applicant: King Chuan Yeh, Taichung City (TW)

(72) Inventor: King Chuan Yeh, Taichung City (TW)

(21) Appl. No.: 14/485,818

(22) Filed: Sep. 15, 2014

(51) Int. Cl. H02K 47/20; H02K 7/116; H02K 7/02; H02K 7/10

(52) U.S. Cl. CPC H02K 47/20; H02K 7/1004; H02K 7/116; H02K 7/02; Y10S 74/09; H02K 53/00

(57) ABSTRACT

A motor-driven electric generator is revealed. The motor-driven electric generator includes a motor and a power generating device. The motor-driven electric generator features on that the power generating device is driven by the motor so as to convert rotational kinetic energy of the motor to electricity.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a motor-driven electric generator, especially to a power generating device that is driven by a motor.

2. Description of Related Arts

Nowadays, electricity is generated by solar energy, wind power, thermal power, hydro power, nuclear power, fuels, etc. However, these power sources require a large amount of force for driving generators to produce power. During the driving process, environmental pollutions are produced. For example, air and the environment are polluted by cloud of dust emitted during thermal power generation. Most hydroelectric power plants have a dam and a reservoir, both having potential impacts on habits and populations of fish. As to nuclear power, it has potential risk of nuclear explosion and the problem of nuclear waste pollution and management. The problems related to Fuel power generation include negative effects on environmental development and pollution, soil pollution and air pollution. In the present invention, a voltage is applied to a motor to generate a rotational force. Then a generator is driven by the rotational force so as to reduce and prevent environmental pollution problems.

### SUMMARY OF THE PRESENT INVENTION

Therefore it is a primary object of the present invention to provide a motor-driven electric generator in which a power generating device is driven by a motor. The small power is used to initiate the motor and further drive the power generating device to generate high power. Thereby the motor only consumes a small amount of energy while kinetic energy is amplified to be used during rotation of the motor. The energy efficiency of the power generating device is improved.

It is another object of the present invention to provide a motor-driven electric generator in which a power generating device is driven by a motor. The rotational kinetic energy of the motor is converted to electricity.

A motor-driven electric generator of the present invention includes a motor and a power generating device.

The motor has a first inertia flywheel while the power generating device includes a second inertia flywheel. The first inertia flywheel and the second inertia flywheel include a shaft respectively. The first inertia flywheel of the motor is connected to the second inertia flywheel of the general power generating device by a belt. By the connection between the first inertia flywheel and the second inertia flywheel, a rotational kinetic energy the motor used to drive the power generating device rotating is converted to electricity.

The power generated by the power generating device moved together with both the inertia flywheels and the motor is sent to a transformer station or a power station for families.

In the present invention, the power generating device is driven by an inertia force of the first inertia flywheel to generate power through the disposition of the motor in combination with the first inertia flywheel. The power generated is output to external electronic devices.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing an embodiment of the present invention;

FIG. 2 is a perspective view of an embodiment of the present invention.

### DETAILED DESCRIPTION OF THE PREFERRED EMBODIMENT

Please refer to following embodiments for details, features and effects of the present invention.

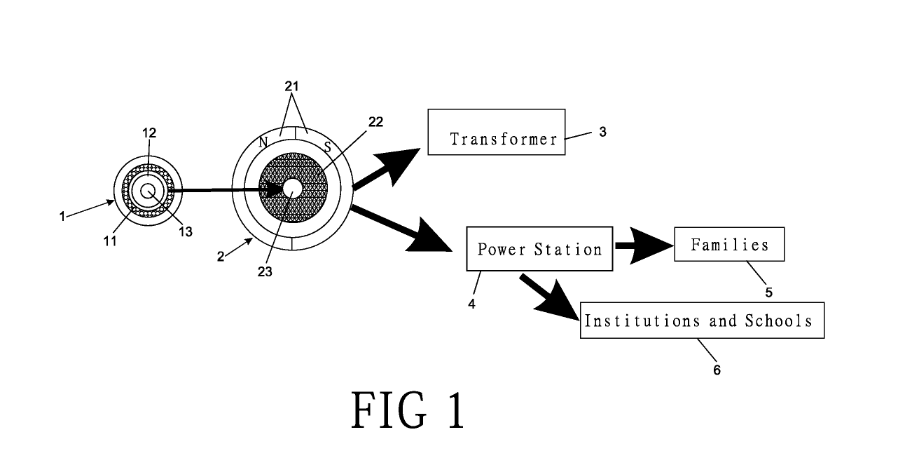

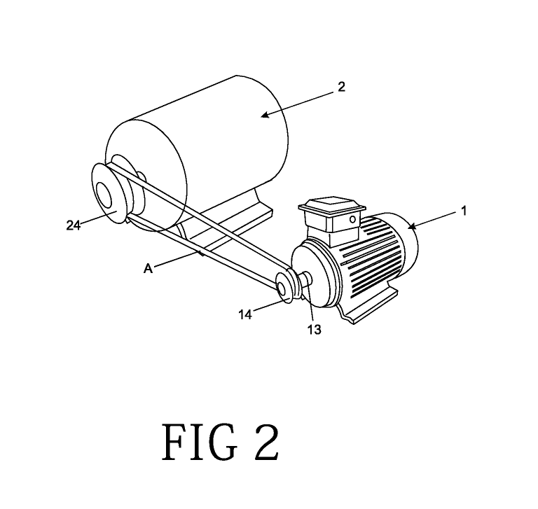

Refer to FIG. 1, a schematic drawing showing structure of an embodiment according to the present invention is revealed. As to the FIG. 2, it's a perspective view of an embodiment of the present invention.

Refer to FIG. 1 and FIG. 2, a motor-driven electric generator of the present invention includes a motor 1 and a power generating device 2.

The motor consists of an outer coil set 11, a rotor 12, a rotating shaft 13 and a first inertia flywheel 14. The outer coil set 11 is disposed around the rotor 12 while the rotating shaft 13 is arranged at the center of the rotor 12. After the outer coil set 11 being applied with a voltage, the rotor 12 is rotated so as to drive the rotating shaft 13 to rotate. This is the structure of a general motor 1.

The power generating device 2 is composed of a magnetic set 21, an inner coil set 22, a drive shaft 23 and a second inertia flywheel 24. This is the structure of a general power generating device 2. By the inner coil set 22 rotating between two poles of the magnetic set 21, induced current is generated due to change of magnetic field in the inner coil set 22. The kinetic energy (the work done by the power) is converted into electricity based on electromagnetic induction.

The power generating device 2 is driven by the motor 1 to produce electricity. Only a little power is required to drive the motor 1 rotating. Then kinetic energy in rotation is used to drive the drive shaft 23 of the power generating device 2 rotating by a transmission device such as transmission belt or gears. Thus the inner coil set 22 is rotated relatively to generate electricity. It should be noted that the inner coil set 22 is at idle rotation so that its output force is smaller while the motor 1 is driven to rotate so that a larger output force is required. Thus the motor 1 is used in the present invention for driving the power generating device 2 to rotate and generating electricity. The transmission device used by the motor 1 to drive the power generating device 2 can be a transmission belt A or a gear set.

Refer to FIG. 2, the motor 1 drives the first inertia flywheel 14 while the inertia flywheel 14 is projecting from and connected to the rotating shaft 13. The second inertia flywheel 24 projecting from and connected to the drive shaft 23 is driven by the general power generating device 2. One end of transmission belt A is arranged around the first inertia flywheel 14 of the motor 1 while the other end thereof is disposed around the second inertia flywheel 24 of the general power generating device 2.

The second inertia flywheel 24 is affected by an inertia force generated during rotation. Thus the second inertia flywheel 24 will not stop rotating immediately when the motor 1 stops driving the second inertia flywheel 24 to rotate. Due to the inertia force, the second inertia flywheel 24 continues rotating for a period of time and then stops rotating. During the rotation of the second inertia flywheel 24 affected by the inertia force, the second inertia flywheel 24 drives the drive shaft 23 of the power generating device 2 to rotate. Thus the power generating device 2 works to produce electricity. Then the power to generated by the power generating device 2 is sent to a transformer station 3 and is used as a power supply of the transformer station 3. Or the power generated is output to a power station 4 and then is sent to families 5 or institutions and schools 6.

Driven by the motor 1, the power generating device 2 is rotated to generate power. The high-voltage power generated by the power generating device 2 is converted into low-voltage power by the transformer station 3. The conversion efficiency of kinetic energy to power used by families or industries is important. If the conversion efficiency is not high, the cost of electricity storage devices is a heavy burden. Thus high efficiency and high utilization of the electricity is an important research and development target for green energy industry. Therefore the present invention provides great benefits to the country, the national defense and the earth.

1. Benefits to the country and the national defense:

1.1 At any time, the country and the national defense become electricity self-sufficient.

1.2 For the country, there is no need to import energy sources including petroleum, coals, natural gas, nuclear energy, etc.

2. Benefits to the earth:

2.1 The most clean power source is provided.

2.2 The present invention helps energy-saving and reduction of carbon dioxide emissions to the most.

2.3 The polluted gas such as carbon dioxide is not emitted in large quantities so as to protect the ecological environment.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A motor-driven electric generator comprising a motor and a power generating device; wherein the motor is used to drive the power generating device so as to produce electricity.

2. The device as claimed in claim 1, wherein a transmission device for the motor to drive the power generating device is transmission belt or a gear set.

3. The device as claimed in claim 1, wherein the motor is disposed with a first inertia flywheel.

4. The device as claimed in claim 1, wherein the power generating device is arranged with a second inertia flywheel.

5. The device as claimed in claim 3, wherein the second inertia flywheel is driven by the first inertia flywheel.

6. The device as claimed in claim 3, wherein a transmission belt is used to connect the first inertia flywheel with the second inertia flywheel and allow the first inertia flywheel driving the second inertia flywheel.
